(19) United States
(12) Patent Application Publication
(10) Pub. No.: US 2013/0227162 A1
(43) Pub. Date: Aug. 29, 2013

(54) Management of Data Upload Speed

(71) Applicants: Jussi KUOSA, Espoo (FI); Hannu Valtonen, Helsinki (FI); Hannu Maaranen, Helsinki (FI); Janne Pankala, Helsinki (FI); Kuan Eeik Tan, Espoo (FI); Jarkko Konola, Oulu (FI); Sami Tikka, Vantaa (FI); Jari Sukanen, Espoo (FI)

(72) Inventors: Jussi KUOSA, Espoo (FI); Hannu Valtonen, Helsinki (FI); Hannu Maaranen, Helsinki (FI); Janne Pankala, Helsinki (FI); Kuan Eeik Tan, Espoo (FI); Jarkko Konola, Oulu (FI); Sami Tikka, Vantaa (FI); Jari Sukanen, Espoo (FI)

(73) Assignee: F-Secure Corporation

(21) Appl. No.: 13/407,887

(22) Filed: Feb. 29, 2012

(51) Int. Cl. G06F 15/173

(52) U.S. Cl. 709/233

(57) ABSTRACT

In accordance with an example embodiment of the present invention, there is provided an apparatus, including a receiver for receiving, from a client device, a data upload request relating to a data management application, wherein a data communications connection having a first data upload speed is utilized between the client device and a data management server; a processor configured to determine whether the client device is allowed to use a second data upload speed on the basis of the received data upload request, wherein the second data upload speed is faster than the first data upload speed; and a processor configured to establish the second data upload speed for the client device, if the client device is allowed to use the second data upload speed.

### TECHNICAL FIELD

The exemplary and non-limiting embodiments of the present application relate generally to methods, apparatuses and computer programs and, more specifically, to the field of data storage management.

### BACKGROUND

More and more data is stored in the cloud which allows users to store data remotely from their own devices. For example, a user may have a large collection of music files that they want to store in a networked data storage that allows them to access those files with any device. Data is stored at a networked server, typically operated by a third party that provides a cloud data storage system. Examples of such systems include Google Cloud Storage, iCloud, DropBox and FilesAnywhere.

Cloud data storage has several advantages. Users do not need to run and maintain physical storage media themselves, but can leave that to the service provider. Furthermore, as cloud storage providers typically have redundancy built into their cloud storage systems, the data is more secure than if it were stored locally in one location and is likely to be lost in the event of a fire, or if the storage medium breaks.

Cloud synchronization services that allow users to synchronize and organize their data between different devices are becoming popular. With synchronization services, users are not required to physically connect their different devices to synchronize data.

Storing data in the cloud and uploading it for synchronization purposes has its problems. For a typical user, the uplink connection bandwidth is relatively small, which means that sending the data from the device to the cloud storage server takes a long time. The amount of digital content, such as photos, videos and music, to be backed up to a safe place or synchronized between different devices is increasing. For example, the initial upload of all the backed up content of a typical user can take several hours and the users may be required to leave their computer devices turned on for a long time during the upload process. When users transfer a large amount of data to their computer device, for example from a video camera, they need to have the data stored on the cloud storage server as easily and quickly as possible.

The way data is uploaded to cloud data management systems needs improvement so that users can upload their files more flexibly and quickly.

### SUMMARY

Various aspects of examples of the invention are set out in the claims.

According to a first aspect of the present invention, there is provided a method for management of data upload speed. The method comprises: receiving, from a client device, a data upload request relating to a data management application, wherein a data communications connection having a first data upload speed is utilized between the client device and a data management server; on the basis of the received data upload request, determining whether the client device is allowed to use a second data upload speed, wherein the second data upload speed is faster than the first data upload speed; and establishing the second data upload speed for the client device, if the client device is allowed to use the second data upload speed.

According to a second aspect of the present invention, thereis provided an apparatus comprising: a receiver for receiving, from a client device, a data upload request relating to a data management application, wherein a data communications connection having a first data upload speed is utilized between the client device and a data management server; a processor configured to determine whether the client device is allowed to use a second data upload speed on the basis of the received data upload request, wherein the second data upload speed is faster than the first data upload speed; and a processor configured to establish the second data upload speed for the client device, if the client device is allowed to use the second data upload speed.

According to a third aspect of the present invention, there is provided a computer program product comprising a computer-readable medium bearing computer program code embodied therein for use with a computer. The computer program code comprises: code for receiving, from a client device, a data upload request relating to a data management application, wherein a data communications connection having a first data upload speed is utilized between the client device and a data management server; code for determining whether the client device is allowed to use a second data upload speed on the basis of the received data upload request, wherein the second data upload speed is faster than the first data upload speed; and code for establishing the second data upload speed for the client device, if the client device is allowed to use the second data upload speed.

### BRIEF DESCRIPTION OF THE DRAWINGS

The accompanying drawings provide a more complete understanding of the embodiments of the present invention according to the following descriptions:

FIG. 1 shows a simplified block diagram that illustrates an example of apparatuses according to the invention;

FIG. 2 shows an example of a method; and

FIG. 3 is a signal sequence diagram showing an example according to an embodiment of the present invention.

### DETAILED DESCRIPTION OF THE DRAWINGS

Example embodiments of the present invention are later described in more detail with reference to the accompanying drawings, in which some embodiments of the invention are shown. The invention may be embodied in many different forms and should not be construed as limited to the embodiments presented here. Although the specification may refer to “an”, “one”, or “some” embodiment in several locations, this does not necessarily mean that each such reference is to the same embodiment, or that the feature only applies to a single embodiment. Single features of different embodiments may also be combined to provide other embodiments.

The present invention can apply to any terminal, server, corresponding component, or to any communication system or combination of different communications systems that support the required functionality. Due to the rapid development of the specifications of computer systems and protocols that are used, all words and expressions should be interpreted broadly; they are intended only to explain the embodiment.

The following description relates to data upload management. This may apply to any type of data, data blocks, complete files or portions of files.

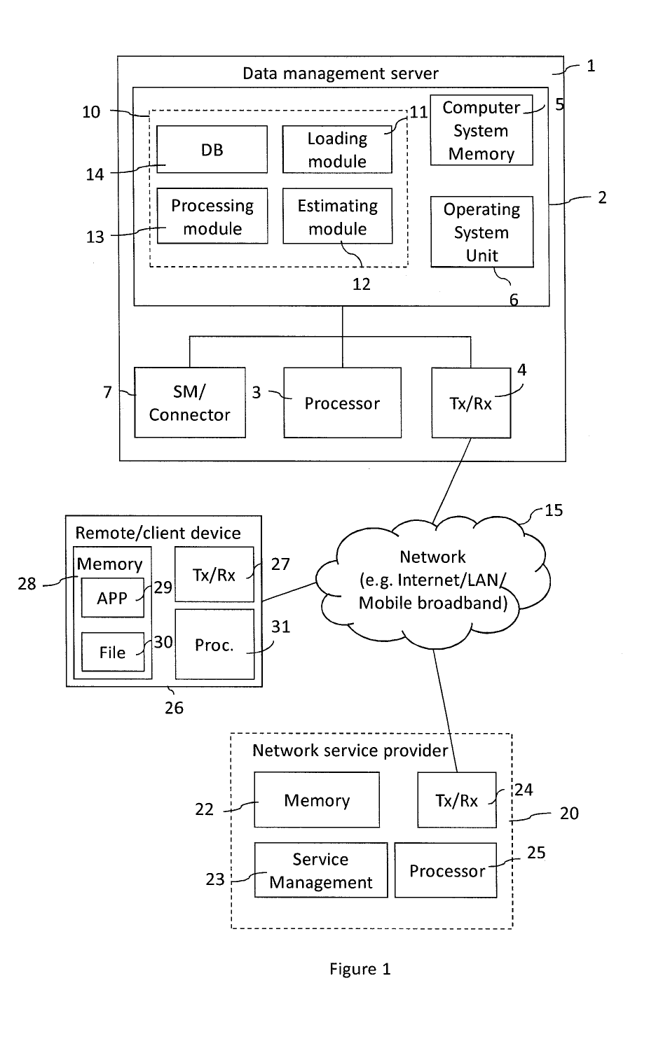

FIG. 1 illustrates a general example of apparatuses in which the embodiments of the invention may be applied. It only shows the elements and functional entities that are required for understanding the arrangement according to an embodiment of the invention. Other components have been omitted for the sake of simplicity. The implementation of the elements and functional entities may vary from that shown in FIG. 1. The connections shown in FIG. 1 are logical connections, and the actual physical connections may be different. It is apparent to a person skilled in the field that the arrangement may also comprise other functions and structures.

FIG. 1 shows an example of a computer system 1, such as data management server that is suitable for implementing the methods that are described below. The computer system 1 can be implemented as a combination of computer hardware and software. The computer system 1 comprises a memory 2, a processor 3 and a transceiver 4. The memory 2 stores the various programs or executable files that are implemented by the processor 3, and provides a computer system memory 5 that stores any data required by the computer system 1.

The programs or executable files that are stored in the memory 2, and implemented by the processor 3, can include an operating system unit 6. The memory 2 also provides a memory 10 that is used by a loading module 11, an estimating module 12, a processing module 13, and a database 14. The loading module 11, estimating module 12, processing module 13 and database 14 can be sub-units of a content storage unit 10, for example. The transceiver 4 is used to communicate over a network 15 such as a LAN, the Internet, or a mobile broadband network. The computer system 1 may be a data management server system, for example.

The example of FIG. 1 also shows a remote terminal 26 that may comprise a processor 31 and a memory unit 28 coupled to a transceiver 27. The memory unit 28 may store data files 30 and applications 29 that a device uses to receive a service. The remote terminal 26 may be a client device or a remote client using the services of the computer system 1, such as a data management server. The remote terminal 26 may use a specific data management application 29 that is stored in the memory 28 for using the services provided by the data management server. For example, when backing up or synchronizing data 30 of the remote terminal 26, users may upload the data to the database 14 of the data management server 1 via the network 15. In some embodiments, the actual data may also be stored on separate disk systems and extracted metadata may be stored in a RDMS (relational database management system) system.

The example of FIG. 1 also shows a network service provider system 20 that may communicate with the computer system 1 and the remote terminal 26. The network service provider 20 may comprise a memory 22, a service management system 23, a transceiver 24 and a processor 25. The computer system 1 may have a connector 7 to the service management system 23 of the network service provider 20, for example. The network service provider 20 may be, for example, an Internet service provider, a wireless service operator, mobile network operator, wireless carrier, cellular company or a mobile network carrier that provides network, voice and data services to subscribers, such as access to the Internet via the network 15.

It should be noted that the computer system 1, the network service provider 20 and the remote terminal 26 are only examples of apparatuses or systems, and that they may have more or fewer components than shown, may combine two or more components, or may have a different configuration or arrangement of the components. For example, in some embodiments the data management server 1 forms a part of the network service provider system 20. There may also be corresponding modules than those of the content storage unit 10 in the remote terminal 26, for example.

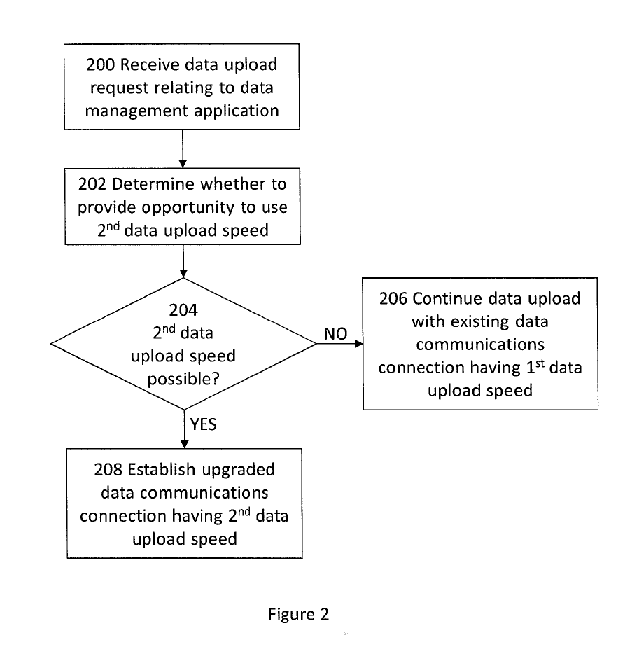

FIG. 2 is a flow diagram that shows an example of a process.

In 200, a data upload request relating to a data management application 29 is received from a client device. A data communications connection having a first data upload speed is utilized between the client device and a data management server. In an embodiment, the data management server 1 receives the data upload request. In another embodiment, the data upload request is first received by the processor 31 of the client device 26, for example.

In 202, for example, the estimating module 12 determines whether the client device 26 is allowed to use a second data upload speed that is faster than the first data upload speed, based on the received data upload request. In an embodiment, the processor 31 of the client device 26 determines whether the client device 26 is allowed to use the second data upload speed.

If in 204 it is detected that the client device 26 cannot be allowed to use the second data upload speed, then 206 is entered where data upload continues with the existing data communications connection at the first data upload speed. If the second data upload speed can be allowed for the client device 26, then 208 is entered.

In 208, the upgraded data communications connection that has the second data upload speed is established for the client device 26.

In an embodiment, the client device 26 may be allowed to use the second data upload speed when a first-time use of a data management application by the client device 26 is detected. For example, it is typical, that when the user backs up or synchronizes content stored in his terminal for the first time, the amount of data to be uploaded to the data management server 1 may be very large. On the other hand, the typical data communications connection that is used by the client device 26 may have a relatively small uplink bandwidth. Sending the backup data over such a link may take a long time due to the increasing amount of digital content, such as photos, videos and music, that the users want to protect.

The first time use of the data management application 29 may be detected, for example, when the client application 29 explicitly requests this from a network service provider or from the data management server. After an authentication process, it may be determined if a particular user is eligible for temporarily higher data upload speed based on the user subscription. In another embodiment, the data management server or the client device notices that the user is new or synchronizes the data for the first time and thus detects the first-time use of the data management application 29. In such cases, the data management server or the client device may request a temporary upgrade to the upload speed from the network service provider for that specific user. In an embodiment, the first time use of the data management application 29 may be determined by seeing the user or device registration date to the data management server and/or by the current usage compared to the user quota in the data management system. Per-user upload statistics may be recorded in the data management application and the average uploads per time window may be calculated that in some embodiments may trigger the upgrade offer for the data communications connection.

In another embodiment, the data management server 1 or the processor 31 of the client device 26 may first receive information that identifies the amount of data to be uploaded. The amount of data may be detected, for example, by analyzing protocol headers to determine how much content is coming in. For example related to HTTP (Hypertext Transfer Protocol) protocol, content-length header may be detected. Analysis of the protocol headers may be applied, for example, in cases where all content is transferred at once. In another embodiment, the client device may estimate the amount of data to be uploaded to the server. The data management application may have full knowledge of the amount of data to be sent and the estimated time of completion, for example.

In another embodiment, the estimate of the amount of data may be included in the communication handshake between the client device and the data management server. The required amount of time for the data upload may then be estimated on the basis of the received information and data upload speed detected. Finally, the client device may be allowed to use the second data upload speed when the estimated required amount of time for the data upload exceeds a predetermined threshold. The predetermined threshold may depend, for example, on current network load such that the upgrade may only be allowed when the network is not very congested. This may be determined, for example, based on time of day or polled from the operator network management systems. In some embodiments, if it is estimated that the upload time would take over an hour, then the client device 26 may be notified about the possibility to upgrade to using the second data upload speed. In an embodiment, the client device 26 may first send a rough estimate of the size of data to be uploaded. The amount of data can then easily be collected by the data management application when it determines the data to be uploaded, for example by querying the file meta-data and summing data sizes together.

The data communications connection can also be automatically upgraded to the second data upload speed in specific situations. For example, the user may have an agreement to automatically upgrade the data communications connection with the data management server 1 or the network service provider in certain situations, for example, when the user has transferred a large amount of new data from a video camera to a device and initiated data backup or synchronization process.

In an embodiment, the data management server 1 may send the client device 26 an invitation to upgrade the data communications connection with the second data upload speed. For example, a dialogue may be displayed to the user of the client device 26 that may give the user an option to upgrade the connection. After receiving the response for upgrading the data communications connection from the client device 26, the upgraded data communications connection for the client device 26 can be established on the basis of the received response.

In an embodiment, establishing the upgraded data communications connection may further comprise the data management server 1 sending a request to the network service provider 20 for configuring the upgraded communications connection. In another embodiment, the client device 26 may send a direct request to the network service provider 20 or to the data management server 1 to establish the upgraded connection.

In an embodiment, the second data upload speed is established for a predetermined time, after which the first data upload speed is restored. The client can be offered an opportunity to continue using the second data upload speed before the first data upload speed is restored. For example, the client may be offered an opportunity to use the second data upload speed for 24 hours after which the first data upload speed is automatically restored.

In an embodiment, the second data upload speed is established at a predetermined point in time and/or for one or more predetermined periods of time. For example, the second data upload speed may be less expensive when established at specific times or for specific time periods of a day and the user may therefore prefer to use the upgraded communications connection during those times.

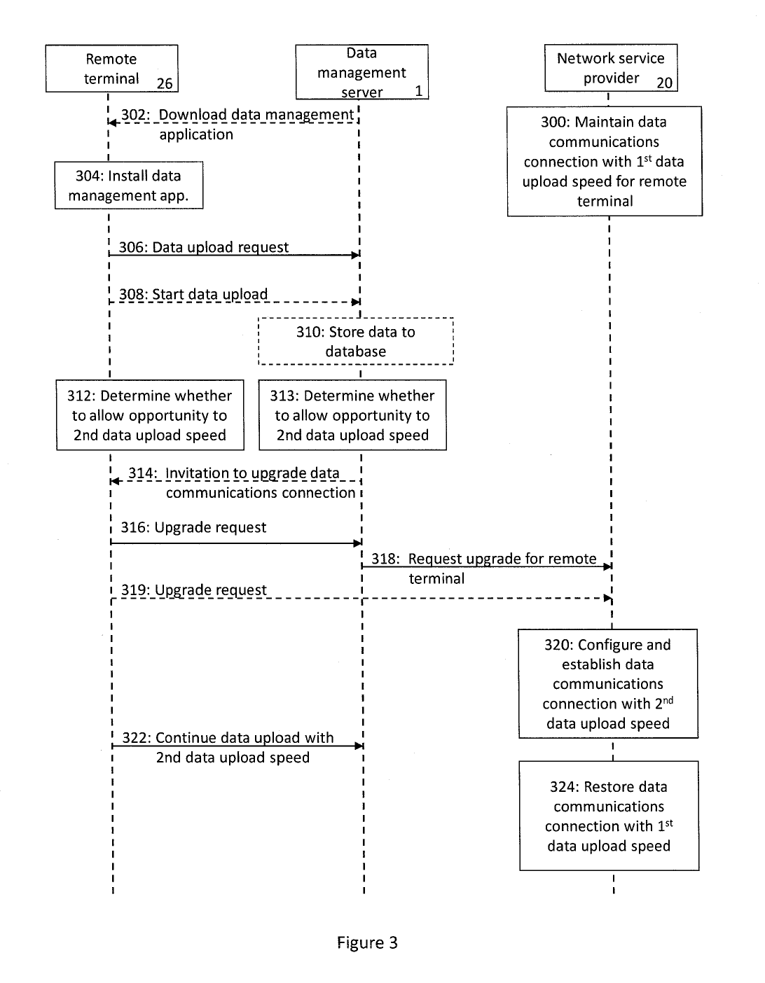

FIG. 3 is a signal sequence diagram that shows another example of the process. At 300, the network service provider 20 maintains data communications connection at the first data upload speed for the remote terminal 26.

In 302, the remote terminal 26 downloads a data management application from the data management server 1. The data management application can also be downloaded from any other service provider, such as from the network service provider 20. The data management application may also be pre-installed in the remote terminal 26 in some scenarios.

In 304, the remote terminal 26 installs the data management application.

In 306, the remote terminal 26 sends a data upload request to the data management server 1 by using the installed data management application. The data management server 1 receives the data upload request and in 308, the data upload can start.

In 310, the data management server 1 stores uploaded data to the database. 306 and 308 can also be delayed until the second data upload speed is in use.

In 312 and 313, the remote terminal 26, the data management server 1 or both determine whether the remote terminal 26 is allowed to use the second data upload speed. In 314, the remote terminal 26 may receive an invitation to upgrade data communications.

In 316, the remote terminal 26 sends an upgrade request to the data management server 1. In some embodiments, the upgrade request may be sent directly to the network service provider 20 as in 319. In an embodiment, the decision whether to allow remote terminal 26 the opportunity to use the second data upload speed may also be determined at the network service provider 20 side after receiving an upgrade request from the remote terminal 26. The network service provider 20 may first determine that the estimated total upload time remaining is too long, for example, and may then decide to allow the remote terminal 26 to select the second data upload speed.

In 318, the data management server 1 sends a request for upgrading the data communications connection of the remote terminal 26 to the network service provider 20. The data management server 1 may, for example, have a connector 7 to a service management system of the network service provider.

In 320, the network service provider 20 configures and establishes an upgraded data communications connection with the second data upload speed for the remote terminal 26.

In 322, the data upload continues with the second data upload speed.

In 324, the data communications connection is restored to the first data upload speed after the upload is finished or after a predetermined time or at a specific point in time.

Without limiting the scope, interpretation, or application of the claims appearing below, the technical effects of one or more of the example embodiments disclosed here improve management of data upload to data storage management system. The embodiments of the invention help preventing loss of time and resources due to significantly reduced data upload times.

The following example use case scenario may comprise the following steps:

S1. An end-user has an existing broad-band Internet connection (for example, 8/1 Mbps),
S2. The end-user purchases a backup service from an Internet service provider,
S3. The end-user installs a backup application,
S4. While the backup client begins to upload data to the server (backend), it may show status or progress information and notify of a possibility to upgrade the Internet connection,
S5. If the end-user accepts to upgrade the connection, the client sends an upgrade request to the backup server,
S6. The backup server may have a connector for a network service management interface that is used to request a service upgrade evaluation,
S7. The network service management system configures the end-user's interface for a faster connection,
S8. The end-user's DSL or cable modem automatically re-negotiates the faster connection and the initial backup is faster,
S9. After the backup process has ended, the end-user may continue to use the upgraded Internet connection or the earlier Internet connection is re-established.

The steps, points, signaling messages and related functions described above in relation to FIGS. 2 and 3 are in no absolute chronological order, and some of the steps may be performed simultaneously or in a different order. Other functions may also be executed between the steps or within the steps, and other signaling messages may be sent between the illustrated ones. Some of the steps can also be left out or replaced by a corresponding step. The system functions illustrate a procedure that may be implemented in one or more physical or logical entities.

The techniques described here may be implemented by various means. An apparatus or system that implements one or more of the described functions with an embodiment comprises not only existing means, but also means for implementing one or more functions of a corresponding apparatus that is described with an embodiment. An apparatus or system may also comprise separate means for each separate function. These techniques may be implemented in hardware (one or more modules) or combinations thereof. For software, implementation can be through modules, for example, procedures and functions that perform the functions described here. The software code may be stored in any suitable data storage medium that is readable by processors, computers, memory unit(s) or articles(s) of manufacture, and may be executed by one or more processors or computers. The data storage medium or memory unit may be implemented within the processor or computer, or as an external part of the processor or computer, in which case it can be connected to the processor or computer via various means known in the field.

The programming, such as executable code or instructions, electronic data, databases or other digital information can be stored into memories and may include a processor-usable medium. A processor-usable medium may be embodied in any computer program product or article of manufacture which can contain, store, or maintain programming, data or digital information for use by or in connection with an instruction execution system, including the processor 3, 25, 31 in the exemplary embodiments.

An embodiment provides a computer program product that comprises a computer-readable medium bearing computer program code embodied therein for use with a computer. The computer program code comprises: code for receiving, from a client device, a data upload request relating to a data management application, wherein a data communications connection having a first data upload speed is utilized between the client device and a data management server; code for determining whether to provide the client device an opportunity to use a second data upload speed on the basis of the received data upload request, wherein the second data upload speed is faster than the first data upload speed; and code for establishing the second data upload speed for the client device, if the client device is provided the opportunity to use the second data upload speed.

Embodiments of the present invention may be implemented in software, hardware, application logic or a combination of these. In an example of an embodiment, the application logic, software or a set of instructions is maintained on any conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

The various aspects of the invention are not limited to the combinations explicitly set out in the independent claims. Other aspects of the invention may comprise combinations of features from the described embodiments, the dependent claims and the independent claims.

It is obvious to a person skilled in the field that, as the technology advances, the inventive concept can be implemented in various ways. The invention and its embodiments are not limited to the examples described above but may vary within the scope of the claims.

What is claimed is:

1. A method for management of data upload speed, comprising:
receiving, from a client device, a data upload request relating to a data management application, wherein a data communications connection having a first data upload speed is utilized between the client device and a data management server;
on the basis of the received data upload request, determining whether the client device is allowed to use a second data upload speed, wherein the second data upload speed is faster than the first data upload speed; and
establishing the second data upload speed for the client device, if the client device is allowed to use the second data upload speed.

2. The method of claim 1, further comprising: allowing the client device to use the second data upload speed when a first-time use of a data management application by the client device is detected.

3. The method of claim 1, further comprising: receiving information identifying the amount of data to be uploaded; estimating the required amount of time for the data upload based on the received information and detected data upload speed; and allowing the client device to use the second data upload speed when the estimated required amount of time for the data upload exceeds a predetermined threshold.

4. The method of claim 1, further comprising: sending to the client device an invitation to upgrade the data communications connection to the second data upload speed; and receiving a response for upgrading the data communications connection from the client device; and establishing, by the data management server or a network service provider, the upgraded data communications connection for the client apparatus on the basis of the received response.

5. The method of claim 1, wherein establishing the upgraded data communications connection further comprises sending, by the client device or the data management server, a request to a network service provider for configuring the upgraded communications connection.

6. The method of claim 1, wherein the second data upload speed is established for a predetermined period of time, and wherein the first data upload speed is restored after the predetermined period of time.

7. The method of claim 1, wherein the second data upload speed is established at a predetermined point of time and/or for one or more predetermined periods of time.

8. An apparatus comprising:
a receiver for receiving, from a client device, a data upload request relating to a data management application, wherein a data communications connection having a first data upload speed is utilized between the client device and a data management server;
a processor configured to determine whether the client device is allowed to use a second data upload speed on the basis of the received data upload request, wherein the second data upload speed is faster than the first data upload speed; and
a processor configured to establish the second data upload speed for the client device, if the client device is allowed to use the second data upload speed.

9. The apparatus of claim 8, wherein the processor is further configured to allow the client device to use the second data upload speed when a first-time use of a data management application by the client device is detected.

10. The apparatus of claim 8, wherein the processor is further configured: to receive information identifying the amount of data to be uploaded; to estimate required amount of time for the data upload on the basis of the received information and data upload speed detected; and to allow the client device to use the second data upload speed when the estimated required amount of time for the data upload exceeds a predetermined threshold.

11. The apparatus of claim 8, further comprising a transmitter configured to send, to the client device, an invitation to upgrade the data communications connection to the second data upload speed; and a receiver configured to receive a response for upgrading the data communications connection from the client device; and a processor configured to establish the upgraded data communications connection for the client device on the basis of the received response.

12. The apparatus of claim 8, wherein the processor is further configured to establish the upgraded data communications connection by sending a request to a data management server or to a network service provider for configuring the upgraded communications connection.

13. The apparatus of claim 8, wherein the processor is further configured to establish the second data upload speed for a predetermined period of time, and to restore the first data upload speed after the predetermined period of time.

14. The apparatus of claim 8, wherein the processor if further configured to establish the second data upload speed at a predetermined point of time and/or for one or more predetermined periods of time.

15. The apparatus of claim 8, wherein at least part of the data management server forms a part of a network service provider system.

16. The apparatus of claim 8, wherein the apparatus or at least part of the apparatus is a client device, a data management server or a network service provider.

17. A computer program product comprising a computer-readable medium bearing computer program code embodied therein for use with a computer, the computer program code comprising:
code for receiving, from a client device, a data upload request relating to a data management application, wherein a data communications connection having a first data upload speed is utilized between the client device and a data management server;
code for determining whether the client device is allowed to use a second data upload speed on the basis of the received data upload request, wherein the second data upload speed is faster than the first data upload speed; and
code for establishing the second data upload speed for the client device, if the client device is allowed to use the second data upload speed.
